(19) United States
(12) Patent Application Publication
(10) Pub. No.: US 2012/0169594 A1
(43) Pub. Date: Jul. 5, 2012

(54) ELECTRONIC DEVICE AND METHOD FOR BACKLIGHT CONTROL

(75) Inventors: Hong Zhao, Naperville, IL (US); Brian Dai, Northbrook, IL (US)

(73) Assignee: MOTOROLA-MOBILITY, INC., Libertyville, IL (US)

(21) Appl. No.: 12/982,474

(22) Filed: Dec. 30, 2010

(51) Int. Cl. G06F 3/033

(52) U.S. Cl. 345/158

(57) ABSTRACT

An electronic device includes a display screen, a backlight for illuminating the display screen, and a timer for indicating the expiration of a given time period, wherein when the backlight is first turned on, the timer is initialized to indicate if the expiration of a first predetermined illumination time period occurs. An image capture component is operable to acquire one or more images of a scene in front of the display screen; and a processor is operable to analyze the one or more images to determine whether a user is present in front of the display screen, to control the timer if a user is determined to be present such that the timer is reset to indicate if the expiration of a second predetermined illumination time period occurs, and to control the backlight to dim it or turn it off if the timer indicates an expiration has occurred.

### FIELD OF THE INVENTION

The present invention relates to an electronic device and corresponding method for controlling a backlight for illuminating a display screen.

### BACKGROUND

Portable electronic devices such as mobile phones, smart phones, personal digital assistants (PDAs), and tablets have become popular and ubiquitous. More and more features and applications have been added to these devices, including call, text. and e-mail functions, internet access, cameras, navigation applications, media storage and display applications, as well as others. These devices typically include a display screen, such as a liquid crystal display (LCD) screen or panel, which generally needs a backlight in order for images to be visible. This is because LCDs do not produce light, unlike for example cathode ray tube (CRT) displays. Specifically, a backlight illuminates an LCD from the back or side of the display panel. Various types of backlights are known, including for example, incandescent light bulbs, light-emitting diodes (LEDs), an electroluminescent panel (ELP), one or more Cold Cathode Fluorescent Lamps (CCFL), or Hot Cathode Fluorescent Lamps (HCFL). In some devices, backlights are controlled to be turned off after a predetermined time period in order to conserve power, because many mobile devices are battery powered and a backlight can be a significant drain on the battery when it is on.

### BRIEF DESCRIPTION OF THE DRAWINGS

FIG. 1 is a front view of an exemplary electronic device in the form of a mobile phone;

FIG. 2 is a block diagram of the exemplary electronic device of FIG. 1; and

FIG. 3 is a flowchart showing steps of an exemplary method that can be performed by the electronic device of FIGS. 1-2.

FIG. 4 is a flowchart showing steps of another exemplary method that can be performed by the electronic device of FIGS. 1-2.

### DETAILED DESCRIPTION

An electronic device having a backlight for illuminating a display screen can include a timer for keeping track of a first predetermined illumination time period, at the end of which an elapsed or expired indication can be provided, and in response to this indication, the backlight can be dimmed and/or turned off in order to conserve power. Because it is also desirable that the backlight not be turned off at a time that is inconvenient to a user, such as when a user is looking at the display screen, a camera of the electronic device can be used to acquire one or more images of a scene in front of the display screen during the first predetermined time period, and a processor can analyze the images to determine whether a user is present, such as by using a face detection algorithm, and can prevent the backlight from being turned off if a user is present. In particular, if it is determined that a user is present, then the timer can be reset so that it provides an indication if an expiration of a second predetermined time period occurs, and the backlight continues to remain on for that additional time (at least in the absence of the backlight being manually turned off). This can be repeated until it is determined that a user is not present, and the timer indicates that an expiration of a set predetermined time period has occurred. The display screen itself and associated control circuitry can also be turned off and on in conjunction with the backlight. In this manner, a balance between a need to conserve power and user convenience can be achieved.

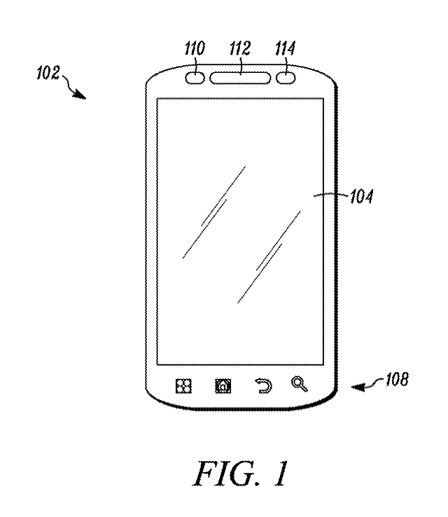

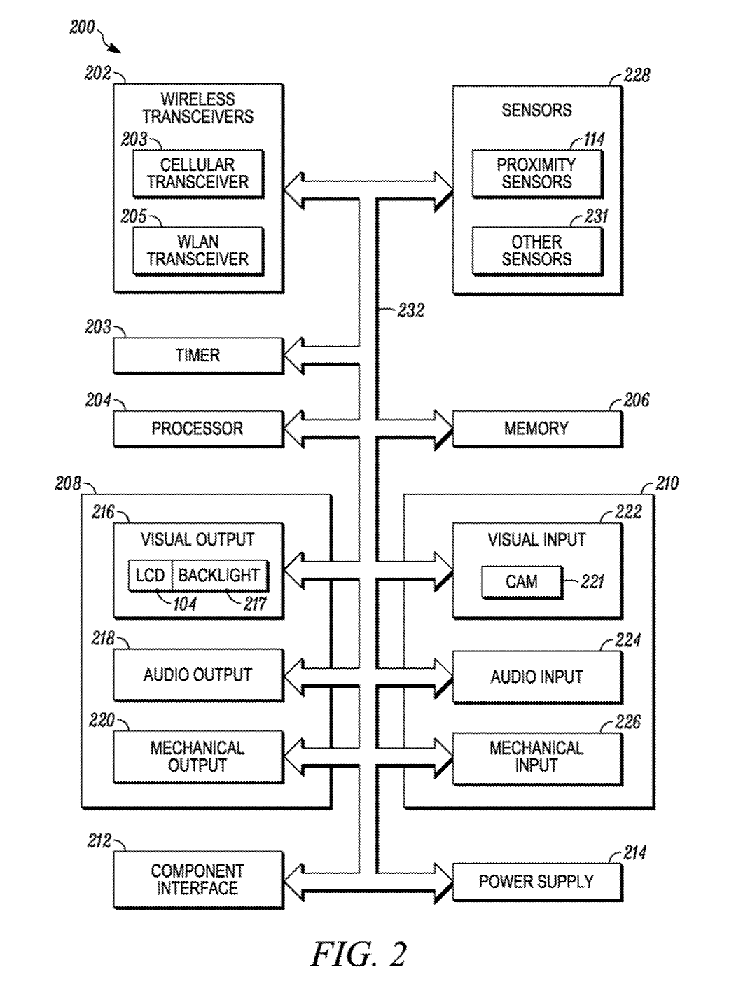

More specifically, as shown in FIG. 1, an exemplary electronic device 102 can take the form of a mobile phone (as more fully described with respect to FIG. 2), which can include functions such as image acquisition, calling, emailing, texting, and internet browsing functions, as well as others. As shown, a front of electronic device 102 can include components such as a display screen 104 which can be in the form of a LCD touch screen and which can be illuminated with a backlight 217 (see FIG. 2) in order for a user to view images on the display screen. The device 102 can also include various control buttons 108, a front facing camera aperture 110 which is associated with a camera 221 (see FIG. 2) for acquiring images of a scene in front of the display screen 104, a speaker component 112 for audio signals, and a proximity sensor 114 for sensing proximity of an object or user with respect to the device. In other embodiments, the electronic device can be one of a variety of other electronic devices having a display screen needing illumination with a backlight, such as a personal digital assistant or tablet, and can include various other functions, features, and/or components.

Referring to FIG. 2, a block diagram 200 illustrates in more detail exemplary internal components of a mobile phone implementation of the electronic device 102. These components can include wireless transceivers 202, a timer 211, a processor 204 (e.g., a microprocessor, microcomputer, application-specific integrated circuit, or the like), memory 206, one or more output components 208, one or more input components 210, and one or more sensors 228, such as one or more proximity sensors 114, and/or other sensors 231 such as an accelerometer, a gyroscope, or any other sensor that can provide pertinent information, such as to identify a current location or orientation of the device 102. The timer 211 is operable to provide an output signal that indicates if an expiration of a given illumination time period occurs, and can be reset to provide an output signal that indicates if an expiration of another given illumination time period occurs. The timer 211 can be implemented in hardware and/or software.

The device 102 can also include a component interface 212 to provide a direct connection to auxiliary components or accessories for additional or enhanced functionality, and a power supply 214, such as a battery, for providing power to the other internal components. All of the internal components can be coupled to one another, and in communication with one another, by way of one or more internal communication links 232 such as an internal bus.

More specifically, the wireless transceivers 202 can include both cellular transceivers 203 and a wireless local area network (WLAN) transceiver 205. Each of the wireless transceivers 202 utilizes a wireless technology for communication, such as cellular-based communication technologies including analog communications (using AMPS), digital communications (using CDMA, TDMA, GSM, iDEN, GPRS, EDGE, etc.), and next generation communications (using UMTS, WCDMA, LTE, IEEE 802.16, etc.) or variants thereof, or peer-to-peer or ad hoc communication technologies such as HomeRF, Bluetooth and IEEE 802.11(a, b, g or n), or other wireless communication technologies.

The memory 206 can encompass one or more memory devices of any of a variety of forms (e.g., read-only memory, random access memory, static random access memory, dynamic random access memory, etc.), and can be used by the processor 204 to store and retrieve data. The data that is stored by the memory 206 can include operating systems, applications, and informational data. Each operating system includes executable code that controls basic functions of the electronic device, such as interaction among the various internal components, communication with external devices via the wireless transceivers 202 and/or the component interface 212, and storage and retrieval of applications and data to and from the memory 206. Each application includes executable code that utilizes an operating system to provide more specific functionality for the communication devices, such as file system service and handling of protected and unprotected data stored in the memory 206. Informational data is non-executable code or information that can be referenced and/or manipulated by an operating system or application for performing functions of the communication device.

The electronic device 102 can be programmed such that the processor 204 and memory 206 interact with the other components of the electronic device to perform various functions, such as to control the backlight 217 as described below.

Exemplary operation of the wireless transceivers 202 in conjunction with others of the internal components of the electronic device 102 can take a variety of forms and can include, for example, operation in which, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output components 208. Likewise, for transmission of wireless signals, the processor 204 formats outgoing information, which may or may not be activated by the input components 210, and conveys the outgoing information to one or more of the wireless transceivers 202 for modulation as communication signals. The wireless transceiver(s) 202 convey the modulated signals to a remote device, such as a cell tower or an access point (not shown).

The input and output components 208, 210 can include a variety of visual, audio, and/or mechanical outputs. For example, the output components 208 can include one or more visual output components 216 such as the display screen 104 (e.g., an LCD screen along with associated control circuitry) and backlight 217 for illumination of the display screen 104, one or more audio output components 218 such as speaker 112, an alarm, and/or buzzer, and one or more mechanical output components 220 such as a vibrating mechanism. Similarly, the input components can include mechanical input components for inputting various user commands for operation of the device, such as a touch screen formed as part of the display screen 104, and/or a keypad and/or control keys 108. Other input components 210 can include one or more visual input components 222 such as camera 221, one or more audio input components 224 such as a microphone. Images acquired by the camera 221 can be saved in memory 206 and analyzed by the processor running a face detection algorithm for example. Actions that can actuate one or more input components 210 can include for example, opening the electronic device, unlocking the device, moving the device, and operating the device.

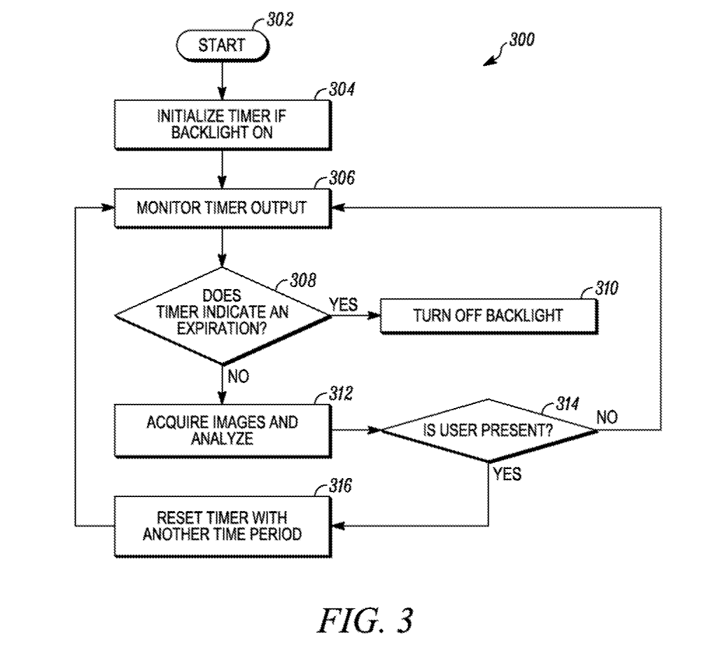

Referring to FIG. 3, flowchart 300 shows steps of an exemplary method that can be performed by the electronic device 102 of FIGS. 1-2 to control the backlight for illumination of the display screen 104. The method starts at a step 302, wherein the electronic device 102 is on. At a step 304, if the backlight is turned on during operation of the device by a user, and if a first predetermined illumination time period is not set to infinity, then the timer is initialized to indicate if an expiration of a first predetermined illumination time period occurs. Note that when the illumination time period is set to infinity, then the backlight time ON period is not controlled by the timer. The first predetermined illumination time period can be a user selectable parameter of the electronic device 102, and if set to infinity, the rest of the method 300 is not performed. The first predetermined illumination time period can be for example a time period having a duration of 30 seconds, 1 minute, 5 minutes, or any value.

Processing then proceeds to a step 306, at which the processor monitors an output control signal of the timer. Processing then proceeds to a step 308. At step 308, it is determined whether the output control signal of the timer indicates that an expiration of a predetermined illumination time period has occurred. If so, then processing proceeds to a step 310, at which the backlight is turned off. Other components, such as the display screen itself and associated control circuitry, can also be controlled to be turned off with the backlight. The method ends after step 310. If no expiration has occurred, then processing proceeds to a step 312.

At step 312, images are acquired and analyzed. In particular, camera 221 with front facing aperture 110 is turned on, and a series of images of a scene in front of the display screen is acquired, with each image corresponding to a preselected time during a respective predetermined time period. The camera can then be turned off. All or a portion of the images are then analyzed to determine whether a user is present, such as by using any one of various known face detection algorithms to detect a face in the images. Known face detection algorithms operate by detecting skin colors, blinking eyes, head shape, various facial features, or other characteristics. In some cases, the first few acquired images can be disregarded due to instabilities of the camera. An accelerometer of the electronic device can be used to help determine orientation to aid in a face detection analysis, such as to determine the expected orientation of a face and/or eyes and/or ears in the images. Processing then proceeds to a step 314.

At step 314, it is ascertained whether a user is present, such as according to the results of the face detection analysis. In some cases, a determination that a face is not present in one image or several successive images is not determinative if it is determined that a face is present in a majority of the other images. For example, not detecting a face in several images may be the result of a user turning his/her face away from the camera for a short time. If a user is determined not to be present, then processing proceeds back to step 306 and the timer output is again monitored. If a user is determined to be present, then processing proceeds to a step 316.

At step 316, the timer is reset to indicate the expiration of another predetermined illumination time period, which can be the same or different time duration as the initial predetermined illumination time period, and can also be a parameter which is set by a user. Processing then proceeds back to step 306 and the timer output is again monitored, and the steps continue from there, in the absence of manual interruption.

Referring to FIG. 3, flowchart 300 shows steps of an exemplary method that can be performed by the electronic device 102 of FIGS. 1-2 to control the backlight for illumination of the display screen 104. The method starts at a step 302, wherein the electronic device 102 is on. At a step 304, if the backlight is turned on during operation of the device by a user, and if a first predetermined illumination time period is not set to infinity, then the timer is initialized to indicate if an expiration of a first predetermined illumination time period occurs. Note that when the illumination time period is set to infinity, then the backlight time ON period is not controlled by the timer. The first predetermined illumination time period can be a user selectable parameter of the electronic device 102, and if set to infinity, the rest of the method 300 is not performed. The first predetermined illumination time period can be for example a time period having a duration of 30 seconds, 1 minute, 5 minutes, or any value.

Processing then proceeds to a step 306, at which the processor monitors an output control signal of the timer. Processing then proceeds to a step 308. At step 308, it is determined whether the output control signal of the timer indicates that an expiration of a predetermined illumination time period has occurred. If so, then processing proceeds to a step 310, at which the backlight is turned off. Other components, such as the display screen itself and associated control circuitry, can also be controlled to be turned off with the backlight. The method ends after step 310. If no expiration has occurred, then processing proceeds to a step 312.

At step 312, images are acquired and analyzed. In particular, camera 221 with front facing aperture 110 is turned on, and a series of images of a scene in front of the display screen is acquired, with each image corresponding to a preselected time during a respective predetermined time period. The camera can then be turned off. All or a portion of the images are then analyzed to determine whether a user is present, such as by using any one of various known face detection algorithms to detect a face in the images. Known face detection algorithms operate by detecting skin colors, blinking eyes, head shape, various facial features, or other characteristics. In some cases, the first few acquired images can be disregarded due to instabilities of the camera. An accelerometer of the electronic device can be used to help determine orientation to aid in a face detection analysis, such as to determine the expected orientation of a face and/or eyes and/or ears in the images. Processing then proceeds to a step 314.

At step 314, it is ascertained whether a user is present, such as according to the results of the face detection analysis. In some cases, a determination that a face is not present in one image or several successive images is not determinative if it is determined that a face is present in a majority of the other images. For example, not detecting a face in several images may be the result of a user turning his/her face away from the camera for a short time. If a user is determined not to be present, then processing proceeds back to step 306 and the timer output is again monitored. If a user is determined to be present, then processing proceeds to a step 316.

At step 316, the timer is reset to indicate the expiration of another predetermined illumination time period, which can be the same or different time duration as the initial predetermined illumination time period, and can also be a parameter which is set by a user. Processing then proceeds back to step 306 and the timer output is again monitored, and the steps continue from there, in the absence of manual interruption.

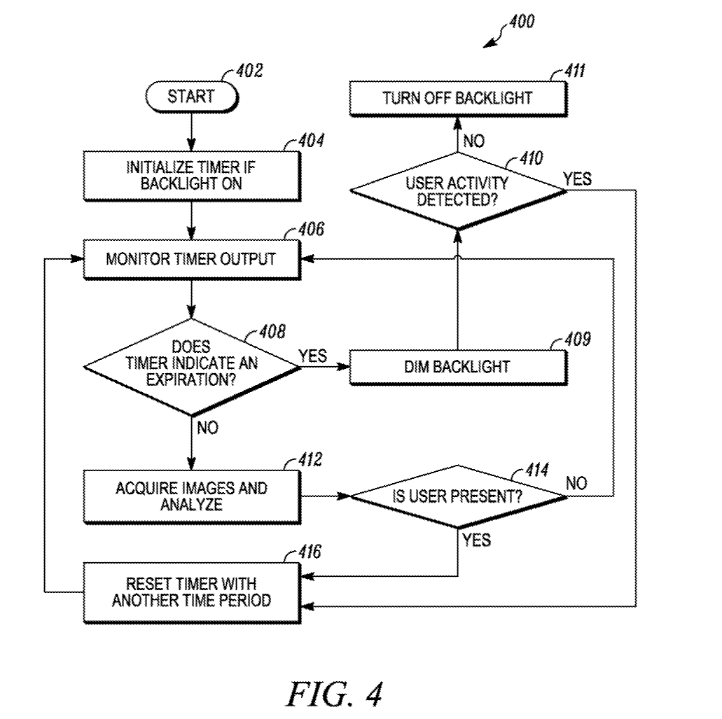

Referring to FIG. 4, flowchart 400 shows steps of another exemplary method that can be performed by the electronic device 102 of FIGS. 1-2 to control the backlight for illumination of the display screen 104, and in particular, to dim the backlight prior to turning it off. The method starts at a step 402, wherein the electronic device 102 is on. At a step 404, if the backlight is turned on during operation of the device by a user, and if a first predetermined illumination time period is not set to infinity, then the timer is initialized to indicate if an expiration of a first predetermined illumination time period occurs. Note that when the illumination time period is set to infinity, then the backlight time ON period or time ON before dimming period is not controlled by the timer. In this case, a first predetermined illumination time period represents a time before the device is dimmed, and can be a user selectable parameter of the electronic device 102, and if set to infinity, the rest of the method 300 is not performed. The first predetermined illumination time period can be for example a time period having a duration of 30 seconds, 1 minute, 5 minutes, or any value.

Processing then proceeds to a step 406, at which the processor monitors an output control signal of the timer. Processing then proceeds to a step 408. At step 408, it is determined whether the output control signal of the timer indicates that an expiration of a predetermined illumination time period has occurred. If so, then processing proceeds to a step 409. If no expiration has occurred, then processing proceeds to a step 412.

At step 409, the backlight is dimmed, and processing then proceeds to a step 410. At step 410, the processor monitors whether any user activity has occurred with respect to the device, such as a touch input on the touch screen or operation of a control button, or the like. This occurs during a relatively short activity monitoring time period (several seconds for example) after the backlight has been dimmed. If user activity is detected, then processing proceeds to a step 416, where the timer is reset with another predetermined illumination time period. If no user activity is detected, then processing proceeds to a step 411, at which the backlight is turned off. The method ends after step 411.

At step 412, images are acquired and analyzed. In particular, camera 221 with front facing aperture 110 is turned on, and a series of images of a scene in front of the display screen is acquired, with each image corresponding to a preselected time during a respective predetermined time period. The camera can then be turned off. All or a portion of the images are then analyzed to determine whether a user is present, such as by using any one of various known face detection algorithms to detect a face in the images. Known face detection algorithms operate by detecting skin colors, blinking eyes, head shape, various facial features, or other characteristics. In some cases, the first few acquired images can be disregarded due to instabilities of the camera. An accelerometer of the electronic device can be used to help determine orientation to aid in a face detection analysis, such as to determine the expected orientation of a face and/or eyes and/or ears in the images. Processing then proceeds to a step 414.

At step 414, it is ascertained whether a user is present, such as according to the results of the face detection analysis. In some cases, a determination that a face is not present in one image or several successive images is not determinative if it is determined that a face is present in a majority of the other images. For example, not detecting a face in several images may be the result of a user turning his/her face away from the camera for a short time. If a user is determined not to be present, then processing proceeds back to step 406 and the timer output is again monitored. If a user is determined to be present, then processing proceeds to a step 416.

At step 416, the timer is reset to indicate the expiration of another predetermined illumination time period (again representative of a time period desired before dimming can occur), which can be the same or different time duration as the initial predetermined illumination time period, and can also be a parameter which is set by a user. Processing then proceeds back to step 406 and the timer output is again monitored, and the steps continue from there, in the absence of manual interruption.

Thus, the backlight can be controlled such that it is prevented from being turned off if a user is determined to be present, which provides a positive user experience and prevents user frustration, and if a user is not present, the backlight will eventually time out and be turned off, which lessens a power drain on the battery and enhances battery life, that is, the time before the battery needs to be recharged.

It is specifically intended that the present invention not be limited to the embodiments and illustrations contained herein, but include modified forms of those embodiments, including portions of the embodiments and combinations of elements of different embodiments as come within the scope of the following claims.

We claim:

1. An electronic device comprising:
a display screen;
a backlight for illuminating the display screen;
a timer for indicating the expiration of a given time period, wherein when the backlight is first turned on, the timer is initialized to indicate if the expiration of a first predetermined illumination time period occurs;
an image capture component for acquiring one or more images of a scene in front of the display screen; and
a processor for analyzing the one or more images to determine whether a user is present in front of the display screen, for controlling the timer if a user is determined to be present such that the timer is reset to indicate if the expiration of a second predetermined illumination time period occurs, and for controlling the backlight if the timer indicates an expiration has occurred.

2. The electronic device of claim 1, wherein a plurality of images is acquired, and each image corresponds to a preselected time measured with respect to the first predetermined illumination time period.

3. The electronic device of claim 1, wherein the processor controls the backlight to dim it or turn it off if the timer indicates an expiration has occurred.

4. The electronic device of claim 3, wherein the processor also controls the display screen and any associated circuitry and turns them off if the timer indicates an expiration has occurred.

5. The electronic device of claim 1, wherein the processor controls the backlight to dim it if the timer indicates an expiration has occurred, and to turn it off in the absence of subsequent user activity with respect to the device for a predetermined monitoring period.

6. The electronic device of claim 1, wherein the first predetermined illumination time period and the second predetermined illumination time period are the same duration.

7. The electronic device of claim 1, wherein the processor uses a face detection algorithm for analyzing the one or more images.

8. The electronic device of claim 7, further including an accelerometer for determining an orientation of the electronic device and wherein the determined orientation is used in the face detection algorithm.

9. The electronic device of claim 1, wherein the display screen is an LCD screen.

10. The electronic device of claim 1, wherein the electronic device is a mobile phone.

11. The electronic device of claim 1, wherein at least one of the first and the second predetermined illumination time periods is adjustable by a user.

12. A method for controlling a backlight for a display screen in an electronic device, the method comprising:
initializing a timer when a backlight is turned on such that the timer will indicate if an expiration of a first predetermined illumination time period occurs;
acquiring a series of images of a scene in front of the display screen;
analyzing the series of images with the electronic device to determine the presence of a user in front of the display screen;
if the presence of a user is detected, then resetting the timer such that the timer will indicate if an expiration of a second predetermined illumination time period occurs; and
controlling the backlight by dimming or turning it off if the timer indicates an expiration has occurred.

13. The method of claim 12, further including repeating the acquiring and analyzing steps, and repeating the resetting step if the presence of a user is again detected, and continuing repetition until the timer indicates an expiration has occurred.

14. The method of claim 12, wherein the first predetermined illumination time period and the second predetermined illumination time period are the same duration.

15. The method of claim 12, wherein the analyzing step includes detecting a face in the images.

16. The method of claim 15, wherein the analyzing step includes determining an orientation of the electronic device.

17. The method of claim 12, further wherein at least one of the first and the second predetermined illumination time periods is adjustable by a user.

18. The method of claim 17, wherein if the first predetermined illumination time period is set to infinity, then the acquiring and analyzing steps are not performed.
